(19) United States
(12) Patent Application Publication
(10) Pub. No.: US 2015/0207716 A1
(43) Pub. Date: Jul. 23, 2015

(54) Monitoring Device, Distributed System Including the Monitoring Device and Method of Monitoring A Distributed System

(71) Applicant: Nexovation, Inc., Hendersonville, TN (US)

(72) Inventor: Robert J. Sexton, Hendersonville, TN (US)

(21) Appl. No.: 14/599,483

(22) Filed: Jan. 17, 2015

Related U.S. Application Data
(60) Provisional application No. 61/928,614, filed on Jan. 17, 2014.

(51) Int. Cl. H04L 12/26; G06Q 30/00

(52) U.S. Cl. CPC H04L 43/10; H04L 43/045; G06Q 30/016

(57) ABSTRACT

A monitoring device for a distributed system includes a signal receiver for receiving a service signal for a service provided by a service provider to a receiving location, and an operating condition indicator which indicates to the service provider an operating condition of the service at the receiving location based on the received service signal.

### BACKGROUND OF THE INVENTION

1. Field of the Invention

The present invention relates to a scheme for monitoring a distributed system, and more particularly, a monitoring device, which can be polled by a service signal from a service provider to indicate an operating condition of the service at the receiving location based on the received service signal.

2. Description of the Related Art

Signal integrity is a set of measures of the quality of an electrical signal. In digital electronics, a stream of binary values is represented by a voltage (or current) waveform. However, digital signals are fundamentally analog in nature, and all signals are subject to effects such as noise, distortion, and loss.

Over short distances and at low bit rates, a simple conductor can transmit an electrical signal with sufficient fidelity. At high bit rates and over longer distances or through various mediums, various effects can degrade the electrical signal to the point where errors occur and the system or device will fail to operate as designed.

Signal integrity is important to service providers of distributed systems such as cable television, broadband systems, satellite TV, utility and data systems. Poor signal integrity can result in ringing, crosstalk, ground bounce, distortion, signal loss, and power supply noise for the customer. Therefore, it is important that the service provider maintain high signal integrity for the customer.

In conventional distributed systems, the service provider is required to dispatch a technician for subscribers having problems with the signal integrity of the service provider's signal or system. This typically requires a technician to perform, at the subscriber's physical location, a check of several parameters to ascertain the problem(s) that the subscriber is experiencing.

The cost of dispatching a technician to ascertain the problem that the subscriber is experiencing is a significant cost to the service provider. Many times the technician finds the service provider's system is not the problem, but that the problem is actually the subscriber's peripheral interfaces, devices, and/or the subscriber's location internal wiring.

In addition to electrical signal integrity and issues surrounding electrical signals, several other areas exist wherein a distributed system might make use of information relating to the performance of the system. For example, a natural gas supplier might make use of gas flow rate and or pressure at the subscriber location, and an electrical power company might make use of the voltage level or power consumption at a subscriber location.

### SUMMARY

In view of the foregoing and other problems, disadvantages, and drawbacks of the aforementioned conventional systems and methods, an exemplary aspect of the present invention is directed to a monitoring device, a distributed system including the monitoring device and a monitoring method for monitoring a distributed system.

An exemplary aspect of the present invention is directed to a monitoring device for a distributed system includes a signal receiver for receiving a service signal for a service provided by a service provider to a receiving location, and an operating condition indicator which indicates to the service provider an operating condition of the service at the receiving location based on the received service signal.

Another exemplary aspect of the present invention is directed to a distributed system including a service transmitter transmitting a service from a service provider at a transmitting location to a subscriber at receiving location which is remote from the transmitting location, and a monitoring device which is located at the receiving location, receives a service signal for the service, and indicates to the service provider an operating condition of the service at the receiving location based on the received service signal.

Another exemplary aspect of the present invention is directed to a monitoring method for monitoring a distributed system. The monitoring method includes receiving a service signal for a service provided by a service provider to a subscriber at a receiving location, and indicating to the service provider an operating condition of the service at the receiving location based on the received service signal.

With its unique and novel features, the present invention provides a monitoring device, distributed system and monitoring method, which are more efficient and effective than conventional devises, systems and methods.

### BRIEF DESCRIPTION OF THE DRAWINGS

The foregoing and other objects, aspects and advantages will be better understood from the following detailed description of the embodiments of the invention with reference to the drawings, in which:

FIG. 1 illustrates a distributed system 100, according to an exemplary aspect of the present invention;

FIG. 2 illustrates a distributed system 100, according to another exemplary aspect of the present invention;

FIG. 3 illustrates a distributed system 100, according to another exemplary aspect of the present invention;

FIG. 4 illustrates a distributed system 100, according to another exemplary aspect of the present invention;

FIG. 5 illustrates a distributed system 100, according to another exemplary aspect of the present invention;

FIG. 6 illustrates a distributed system 100, according to another exemplary aspect of the present invention;

FIG. 7 illustrates a distributed system 100, according to another exemplary aspect of the present invention;

FIG. 8 illustrates a monitoring device 120 which may be used in the distributed system 100, according to another exemplary aspect of the present invention;

FIG. 9 illustrates a monitoring device 120 which may be used in the distributed system 100, according to another exemplary aspect of the present invention;

FIG. 10 illustrates a monitoring device 120 and user device 140 which may be used in the distributed system 100, according to another exemplary aspect of the present invention;

FIG. 11 illustrates a monitoring method 1100 for monitoring a distributed system (e.g., distributed system 100), according to another exemplary aspect of the present invention;

FIG. 12 illustrates a schematic block diagram of a wired distributed system 1200 including a monitoring device 100, according to an exemplary aspect of the present invention; and

FIG. 13 illustrates a schematic block diagram of a wireless distributed system 1300 including a monitoring device 100, according to an exemplary aspect of the present invention.

### DETAILED DESCRIPTION OF SOME EXEMPLARY EMBODIMENTS OF THE INVENTION

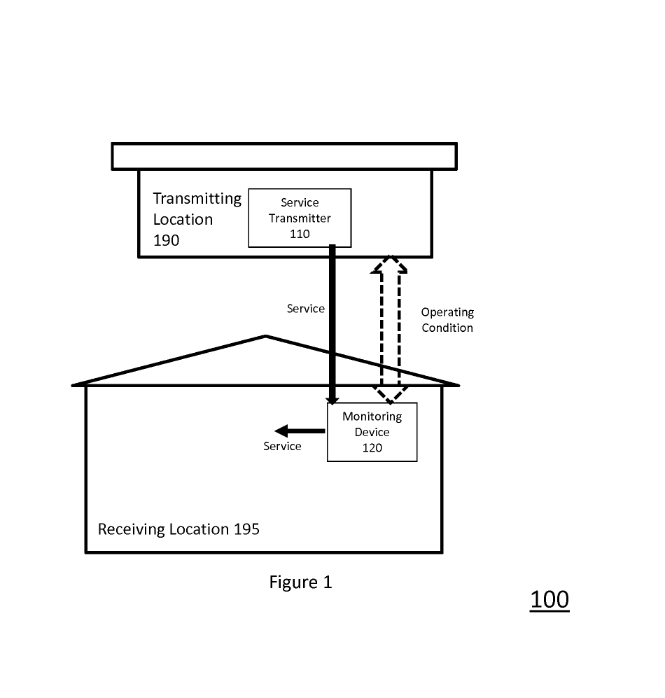

Referring now to the drawings, FIGS. 1-13 illustrate the exemplary aspects of the present invention.

The present invention is directed to signal monitoring and more particularly to the technical field of continuous operational conditions monitoring and reporting or signal integrity monitoring and reporting of distributed systems. In particular, the present invention may include a subscriber location-based, inline, continuous operational conditions monitoring and reporting or signal integrity monitoring and reporting system for voice, data, audio, video, power and other distributed systems.

Even more particularly, the present invention is directed to the technical field of continuous monitoring and reporting of utility, voice, data, audio, video and power distributed systems, such as cable television, broadband systems, satellite TV, utility and data systems.

In view of the foregoing and other exemplary problems, if the provider, technician or subscriber had real-time, instant access to several key parameters of the distributed systems' operational conditions or signal integrity, the provider could potentially and significantly reduce the number of technician dispatches, or, at the very least, the service time required for each technician dispatch.

In an exemplary embodiment, the present invention is directed to an operational conditions monitoring and reporting or signal integrity monitoring and reporting system for voice, data, audio, video and power distributed systems, such as broadband communications systems and satellite TV and data systems.

FIG. 1 illustrates a distributed system 100, according to an exemplary aspect of the present invention.

As illustrated in FIG. 1, the distributed system 100 includes a service transmitter 110 transmitting a service from a service provider at a transmitting location 190 to a subscriber at receiving location 195 which is remote from the transmitting location 190, and a monitoring device 120 which is located at the receiving location 195, receives a service signal for the service, and indicates to the service provider an operating condition of the service at the receiving location 195 based on the received service signal. For example, the service provider may be able to access data stored on the monitoring device 120 or generated by the monitoring device 120, or the monitoring device 120 may transmit (e.g., transmit a signal (e.g., data signal) by wire or wirelessly) the operating condition to the service provider.

It should be noted that the monitoring device 120 may indicate the operating condition of these service in real time to the service provider. In particular, the operating condition indicated by the monitoring device 120 may include a time or other parameters that correspond to the indicated operating condition. Thus, for example, the operating condition may indicate that the signal integrity of a cable television signal had a first value at a first time, a second value at a second time, and so on.

In an aspect of the present invention, since the monitoring device 120 may be accessible by the service provider 190 and/or the operating condition is transmitted to the service provider, the service provider 190 may be able to diagnose a problem with a subscriber's service without needing to travel to the receiving location 195 (e.g., the home, office, etc. of the subscriber). That is, in an exemplary aspect of the present invention, the checks that are conventionally performed by a service technician at the receiving location 195 of the subscriber, may be performed remotely based on the operating condition indicated by the monitoring device 120.

These features may allow the service provider 195 to avoid the expense of dispatching a technician to ascertain the problem that a subscriber is experiencing, saving significant costs to the service provider 195. The features may also help to reduce the time needed to repair or replace service to the subscriber, reducing inconvenience to the subscriber.

The distributed system 100 may include any service that is provided by an input to the receiving location 195. For example, the distributed system 100 may include a cable television system, a broadband telecommunications system, a satellite television system, an electrical power system, a data system, a natural gas distribution system and a water distribution system. Thus, the service provided by the service provider may include cable television service, telephone service, broadband telecommunications service, satellite television service, electrical power service, data service, natural gas distribution service and water distribution service.

The transmitting location 190 may include, for example, an electrical power plant which provides electrical power service, a cable television station which provides cable television service, a natural gas production plant which provides natural gas service, and so on. The transmitting location 190 may also be a relay station or some other structure used by the service provider to transmit or relay the service to a subscriber of the service at the receiving location 195. The receiving location 195 may include a house, building or other structure, which is serviced by the service provider.

The operating condition indicated by the monitoring device 120 may vary depend upon the service. For example, where the service is provided to the subscriber as a gas or liquid in a pipe, the operating condition may include a flow rate or pressure within the pipe. Where the service is provided in the form of an electrical signal, the operating condition may include a signal strength of the electrical signal, a frequency range of the electrical signal, a data rate for the electrical signal, data integrity of the electrical signal, crosstalk for the electrical signal and interference with the electrical signal.

In a case where the service includes an electrical signal such as a cable television signal, the service signal and the electrical signal of the service may be the same signal. That is, the service signal may be a cable television signal, a broadband signal, and so on. In this case, as illustrated in FIG. 1, the monitoring device 120 may receive the service (e.g., cable television signal). That is, the service may be input to the monitoring device 120 (e.g., input directly into the monitoring device 120).

As illustrated in FIG. 1, the monitoring device 120 may be located in a house, building or other structure at the Receiving Location 195. In particular, the monitoring device 120 may be located adjacent to an electrical circuit breaker box in a home, building or other structure. Alternatively, the monitoring device 120 may be located outside of any house, building or other structure at the Receiving Location 195. For example, the monitoring device 120 may be located on an outer wall of a house, building or other structure adjacent to a natural gas meter, an electricity meter, a water meter and so on.

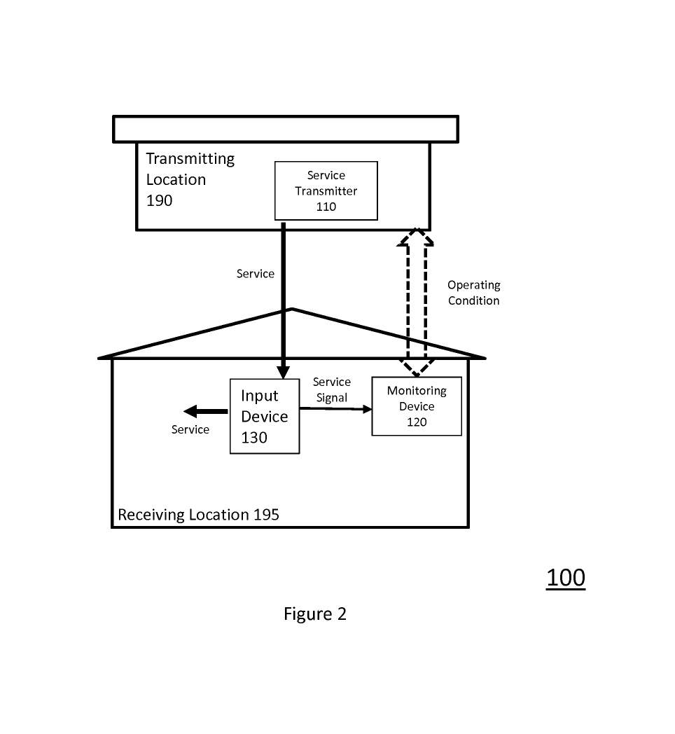

FIG. 2 illustrates a distributed system 100, according to another exemplary aspect of the present invention.

As illustrated in FIG. 2, the service may be received by an input device 130 at the receiving location 195 and distributed in the receiving location 195 from the input device 130. In this case, the service signal may be generated by the input device 130 and transmitted (e.g., by wire or wireless signal) to the monitoring device 120.

This arrangement may be used, for example, in a case where the service does not include a wired electrical signal, such as a radio or television broadcast service, a satellite television service, a natural gas service or a water service. For example, where the service is a radio or television broadcast service the input device 130 may include an antenna, where the service is a satellite television service the input device 130 may include a satellite dish, where the service is a natural gas or water service the input device 130 may include a flow meter or pressure sensor, and so on.

For example, the input device 130 (e.g., flow meter) may detect a flow rate in a natural gas line or water line feeding the natural gas or water into a home at the receiving location 195, and transmit a service signal for the service to the monitoring device 120 which would indicate the flow rate in the natural gas or water line at the receiving location 195 based on the received service signal. The input device 130 (e.g., pressure sensor) may alternatively detect a pressure in the natural gas line or water line, and transmit a service signal for the service to the monitoring device 120 which would indicate the pressure in the natural gas or water line at the receiving location 195 based on the received service signal.

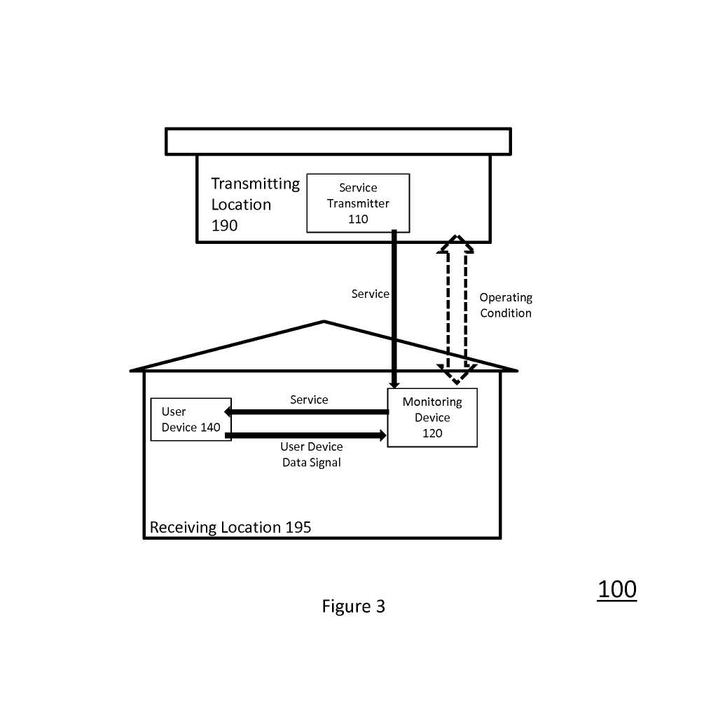

FIG. 3 illustrates a distributed system 100, according to another exemplary aspect of the present invention.

As illustrated in FIG. 3, the distributed system 100 may include a user device 140 which uses the service and is located at the receiving location 195. For example, the user device 140 may include a television (which uses electrical power service and cable television service), a telephone, a set-top box, a modem, a computer, a network router, a security device, a light fixture, a heating, ventilation and air conditioning (HVAC) unit, an electrical appliance such as an electric toaster, electric clothes washer or electric clothes dryer, a gas appliance such as a gas stove, gas water heater or gas fireplace, and a water faucet.

As illustrated in FIG. 3, the user device 140 may generate a user device data signal regarding an operating condition of the service at the user device 140. For example, in an exemplary embodiment, the user device data signal may indicate whether the service is present at the user device 140. The user device 140 may transmit the user device data signal to the monitoring device 120 which, based on the received user device data signal, indicates the operating condition of the service at the user device 140.

As illustrated in FIG. 3 and noted above, the user device 140 may generate the user device data signal and transmit it to the monitoring device 120. For example, the user device 140 may include a transmitter for transmitting the user device data signal by wire to the monitoring device 120 which may include a receiver for receiving the user device data signal. Alternatively, the user device 140 may include a wireless transmitter (e.g., bluetooth transmitter, radio frequency (RF) transmitter, etc.) which wirelessly transmits the user device data signal to the monitoring device 120 which may include a wireless receiver for receiving the user device data signal.

In an exemplary embodiment, the user device 140 may be connected to the monitoring device 120 (e.g., by wire or wirelessly) by a network (e.g., a home network, office network, etc.), so that transmitter of the user device 140 may transmit the user device data signal via the network to the monitoring device 120.

It should be noted that although FIG. 3 illustrates the service being delivered to the user device 140 via the monitoring device 120, this is not a necessary arrangement. That is, it is possible that the user device 140 receives the service other than through the monitoring device 120 (e.g., such as directly from the service transmitter 110).

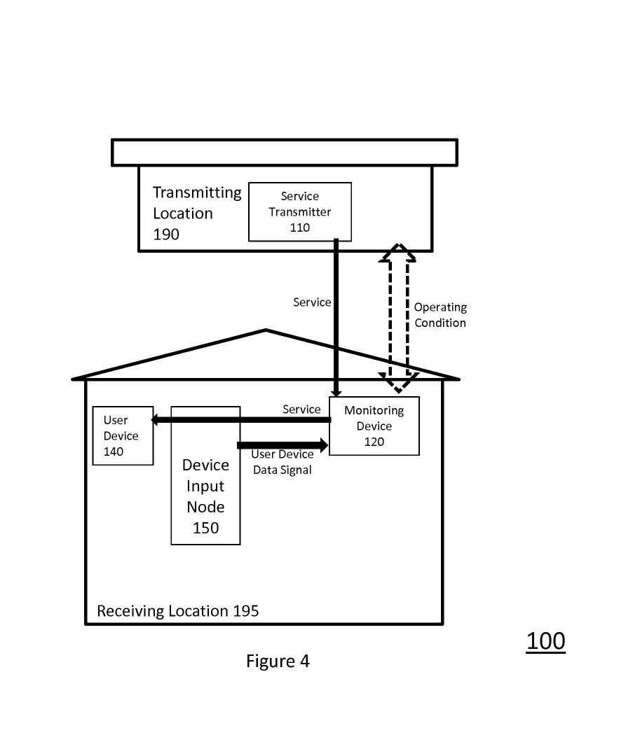

FIG. 4 illustrates a distributed system 100, according to another exemplary aspect of the present invention.

As illustrated in FIG. 4, the distributed system 100 may further include a device input node 150, which is connected between the monitoring device 120 and the user device 140. The device input node 150 may include a capability for communicating (e.g., by wire or wirelessly) with the monitoring device 120. The device input node 150 may generate and transmit the user device data signal to the monitoring device 120 in a similar manner as described above for the user device 140. This arrangement may be useful for older user devices 140 which do not include a capability of communicating (e.g., by wire or wirelessly) with the monitoring device 120.

For example, for a cable television service, the device input node 150 may be connected to the coaxial service port in wall, and a coaxial cable may be connected to the device input node 150 and to the back of a set-top box receiving the cable television service. For a natural gas service, the device input node 150 may include a flow meter or pressure sensor connected to the natural gas line near to a gas appliance which uses the natural gas service (e.g., gas water heater, gas stove, gas fireplace, etc.).

These features may allow the monitoring device 120 to more accurately identify a location of an interruption of service at the receiving location. For example, in conventional systems, a natural gas service subscriber may detect a natural gas odor in his home and determine that there is a leak in a natural gas line, but not be able to identify the location of the leak. In an exemplary aspect of the present invention, on the other hand, the distribution system 100 may use the user device data signals generated and transmitted from various points on the gas lines in the home to narrow down the location of a gas leak to a particular room in the home or a particular gas appliance in the home.

It should be noted that the distributed system 100 may include a plurality of service transmitters 110 located at a plurality of transmitting locations 190, respectively, a plurality of monitoring devices 120 located at a plurality of receiving locations 195, respectively, and a plurality of user devices 150 located at the plurality of receiving locations 195. Further, the receiving location 195 may include a plurality of user devices 150 which transmit user device data signals to the monitoring device 120.

Further, as with the user device, it is possible that the input node 150 receives the service other than through the monitoring device 120 (e.g., such as directly from the service transmitter 110).

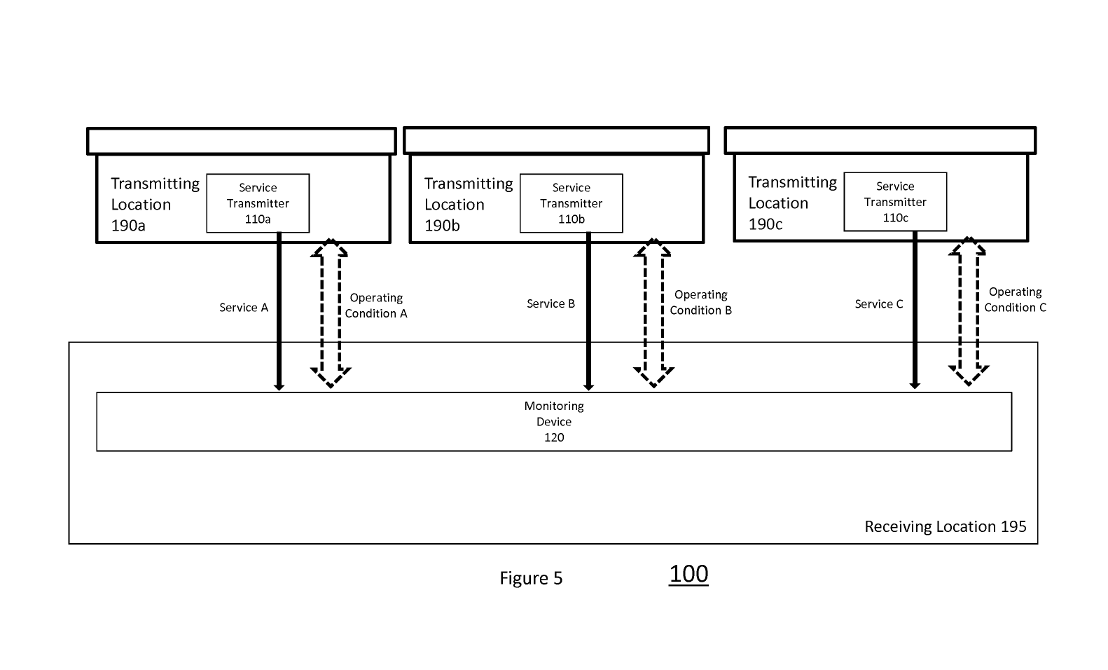

FIG. 5 illustrates a distributed system 100, according to another exemplary aspect of the present invention.

As illustrated in FIG. 5, the distributed system 100 may include a plurality of service transmitters 110a, 110b and 110c transmitting services A, B and C from transmitting locations 190a, 190b and 190c, respectively. In this case, the monitoring device 120 may receive service signals for the services A, B and C, and indicate operating condition A, B and C of the services A, B and C. Further, the monitoring device 120 may be accessible by the service providers represented by 190a, 190b and 190c or the monitoring device 120 may transmit (e.g., by wire or wirelessly) the operating condition to the service providers 190a, 190b and 190c).

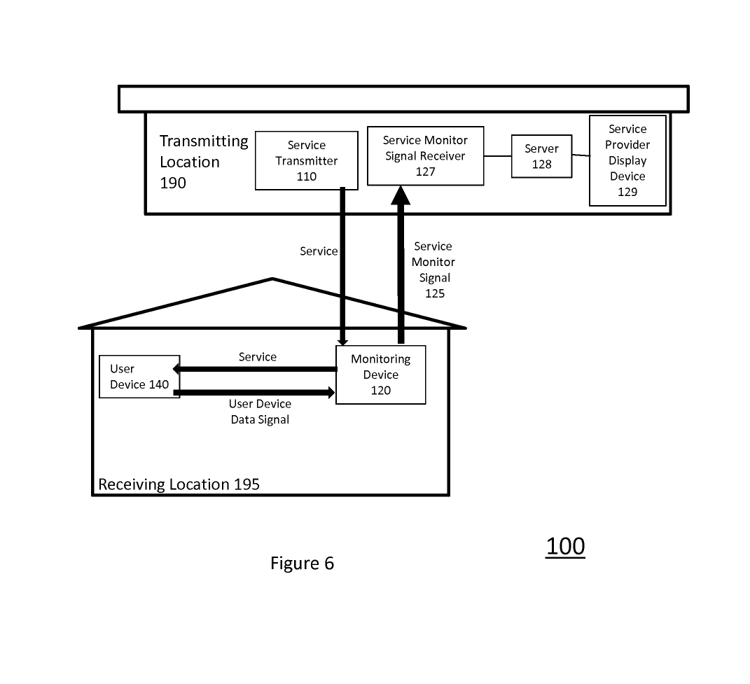

FIG. 6 illustrates a distributed system 100, according to another exemplary aspect of the present invention.

As noted above, in an exemplary aspect of the present invention, the monitoring device 120 (and thus the operating condition of the service) may be accessible by the service provider 190. The distributed system 100 may include one or more mechanisms for making the monitoring device 120 (and thus the operating condition of the service) accessible by the service provider.

As illustrated in FIG. 6, the monitoring device 120 may indicate the operating condition of the service by transmitting a service monitor signal 125 to the service provider of the service. In particular, the monitoring device 120 may transmit the service monitor signal 125 directly to the service provider at the transmitting location 190, via a service center for the distributed system 100, and/or via a portable terminal of a service technician for the service provider.

The distributed system 100 may also include a service monitor signal receiver 127 at the transmitting location 190 or at another location. For example, the service monitor signal receiver 127 may be included a handheld device (e.g., mobile phone) which is in the possession of a service technician for the service provider.

In one exemplary aspect, the monitoring device 120 may include a cellular transmitter, which transmits the service monitor signal 125 to the service monitor signal receiver 127 via a cellular connection between the monitoring device 120 and the service monitor signal receiver 127. In another exemplary aspect, the monitoring device 120 may include a signal transmitter, which transmits the service monitor signal 125 to the service monitor signal receiver 127 via a wired link (e.g., telephone line, broadband connection, electrical power line, etc.) between the monitoring device 120 and the service monitor signal receiver 127.

The distributed system 100 may also include a server 128 that receive data (e.g., the service monitor signal) from the service monitor signal receiver 127 and execute an application (e.g., software application) for monitoring the service at the receiving location 195. The server 128 may include a memory for storing history data for service at the receiving location 195. For example, the history data may describe a history of the service signal, which is input to the receiving location 195, and the various user device data signals which are transmitted to the monitoring device 120.

The distributed system 100 may also include a service provider display device 129 (e.g., touchscreen display device), which is connected to the server 128. In executing the application for monitoring the service at the receiving location 195, the server 128 may generate an operating condition display (e.g., graphical user interface (GUI)) and cause the service provider display device 129 to display the operating condition display for the distributed system 100 based on the received service monitor signal.

As noted above, the operating condition indicated by the monitoring device 120 may include a time or other parameters that correspond to the indicated operating condition. For example, the operating condition display may allow the subscriber and the service provider to conveniently compare operating conditions at different user devices across a plurality of services. For example, it may allow a subscriber to correlate a spike in the electrical power supply coming into the subscriber's home, with a diminished quality of the cable television signal, or with a diminished quality of the subscriber's cellular service, and so on.

The monitoring device 120 may include a primary mechanism for transmitting the service monitor signal to 125 to the service monitor signal receiver 127, and at least one back-up mechanism for transmitting the service monitor signal to 125 to the service monitor signal receiver 127. For example, the monitoring device 120 may be programmed to transmit the service monitor signal 125 to the service monitor signal receiver 127 via a cellular connection, and in the event that the cellular connection is lost, the monitoring device 120 may switch to transmitting the service monitor signal 125 via a telephone line connection between the monitoring device 120 and the service monitor signal receiver 125.

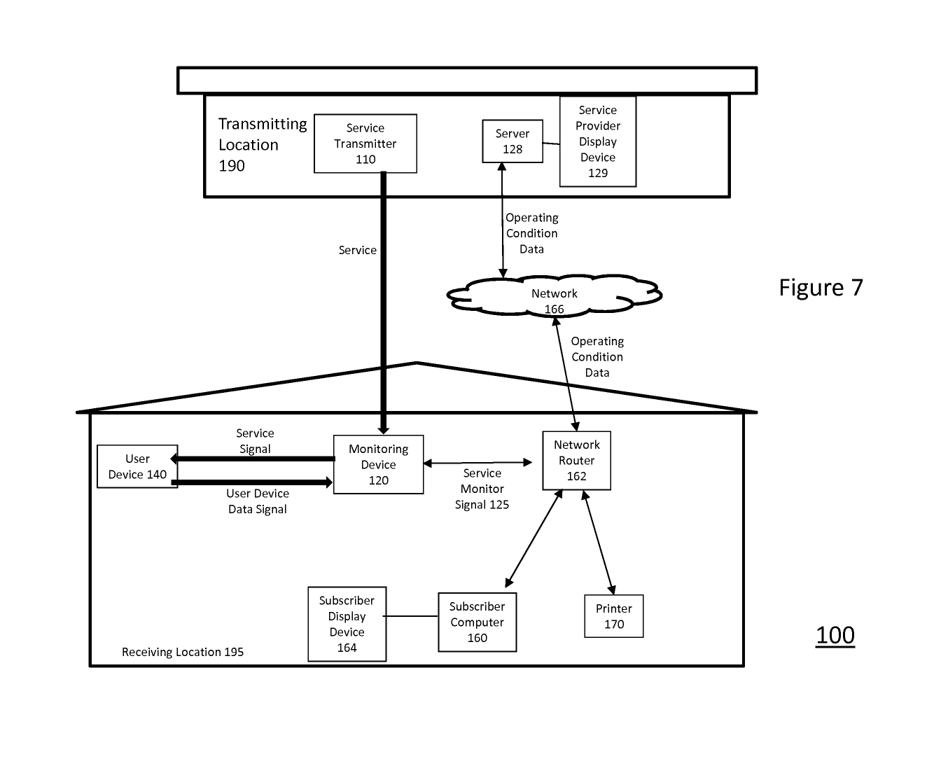

FIG. 7 illustrates a distributed system 100, according to another exemplary aspect of the present invention.

As illustrated in FIG. 7, in an exemplary aspect, the mechanism used by the distributed system 100 to communicate (e.g., indicate) the operating condition of the service at the receiving location 195 is a network connection (e.g., via a wired or wireless network) such as the Internet.

That is, in an exemplary aspect, the distributed system 100 may include subscriber computer 160 at the receiving location 195. The subscriber computer 160 may access the monitoring device 120 directly (e.g., by wired or wireless connection), or may access the monitoring device 120 via a network router 162 which is part of the network (e.g., home network) at the receiving location 195, so that the service monitor signal 125 (e.g., operating condition data) is transmitted to the subscriber computer 160.

The subscriber computer 160 may execute an application (e.g., software application) for monitoring the service at the receiving location 195, and in executing the application, the subscriber computer 160 may generate an operating condition display (e.g., graphical user interface (GUI)) and cause the subscriber display device 164 (e.g., touchscreen display device) to display the operating condition display for the distributed system 100 based on the service monitor signal. The subscriber computer 160 may also cause the operating condition display or other data produced by the subscriber computer 160 based on the service monitory signal 125, to be printed on a printer 170, which is connected to the network router 162 in the distributed system 100.

The subscriber computer 160 may also include an input device (e.g., keyboard, mouse, etc.) for programming (e.g., controlling) the monitoring device 120 or other features of the distributed system 100 at the receiving location 195. For example, the subscriber computer 160 may be used to set a predetermined condition in the monitoring device 120 which if detected by the monitoring device 120, would cause the subscriber computer 160 to notify (e.g., automatically notify) the subscriber, the security provider, emergency personnel such as the police or fire department, etc. For example, if the predetermined condition is detected, the subscriber computer 160 may activate an audible or visual alarm at the receiving location 195, or may initiate a phone call to the subscriber, the security provider and/or emergency personnel.

The input device may also be used to manipulate data such as operating condition data and configure the operating condition display and other features of the distributed system 100.

The subscriber computer 160 may also communicate (e.g., indicate) the operating condition of the service at the receiving location 195 to the server 128 of the service provider by transmitting operating condition data via the network router 162 and network 166 (e.g., the Internet). For example, the operating condition data may include the service monitor signal 125 and/or data for generating the operating condition display, which was generated by the subscriber computer 160.

The server 128 may (e.g., by executing the application (e.g., software application) for monitoring the service at the receiving location 195) use the operating condition data to cause the service provider display device 129 to generate the operating condition display.

Alternatively, the service provider may use the server 128 to access the monitoring device 120 at the receiving location 195. That is, the service provider may use the server 128 to access the monitoring device 120 on their end, via the network 166 and the network router 162. This may be performed, for example, by the subscriber providing the service provider with a password for accessing the monitoring device 120, while denying the service provider access to the remainder of the network at the receiving location 195.

Further, in this exemplary aspect, the service provider at the transmitting location 190 and the subscriber at the receiving location 195 may view the operating condition display at the same time, which will allow the service provider and subscriber to better communicate with each other regarding the operating condition of the service, and to perform a diagnostic evaluation of and issues that may arise with operating condition of the service in the distributed system 100.

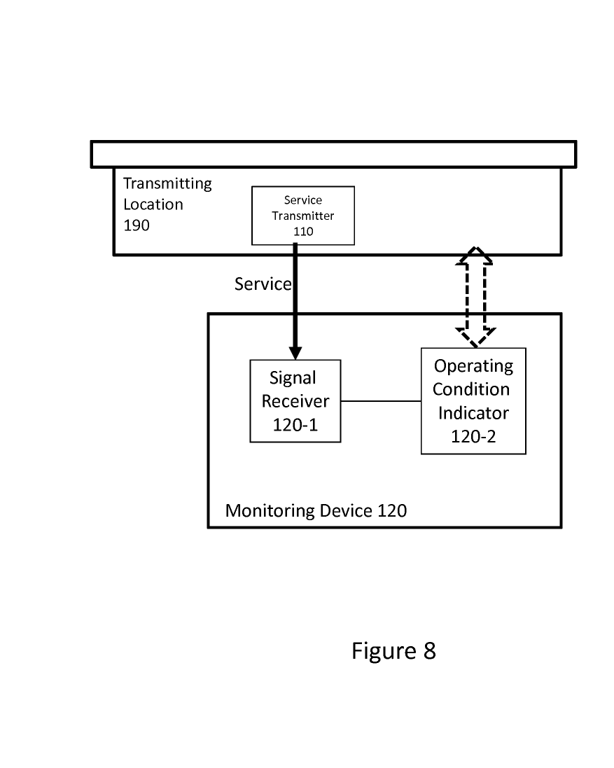

Referring again to the drawings, FIG. 8 illustrates a monitoring device 120 which may be used in the distributed system 100, according to another exemplary aspect of the present invention.

As illustrated in FIG. 8, the monitoring device 120 includes a signal receiver 120-1 for receiving the service signal for the service provided by the service provider to the receiving location 195. The monitoring device 120 also includes an operating condition indicator 120-2 which indicates to the service provider the operating condition of the service at the receiving location 195 based on the received service signal. The monitoring device 120 may be accessible by the service provider and/or may transmit the operating condition to the service provider.

The signal receiver 120-1 may include a receiver for receiving a wired or wireless signal. As noted above, where the service includes an electrical signal, the service signal may be the service. For example, where the service is a cable television signal which is transmitted to the monitoring device 120 by a coaxial cable, the coaxial cable may be connected to the signal receiver 120-1 so that the signal receiver 120-1 receives the cable television signal.

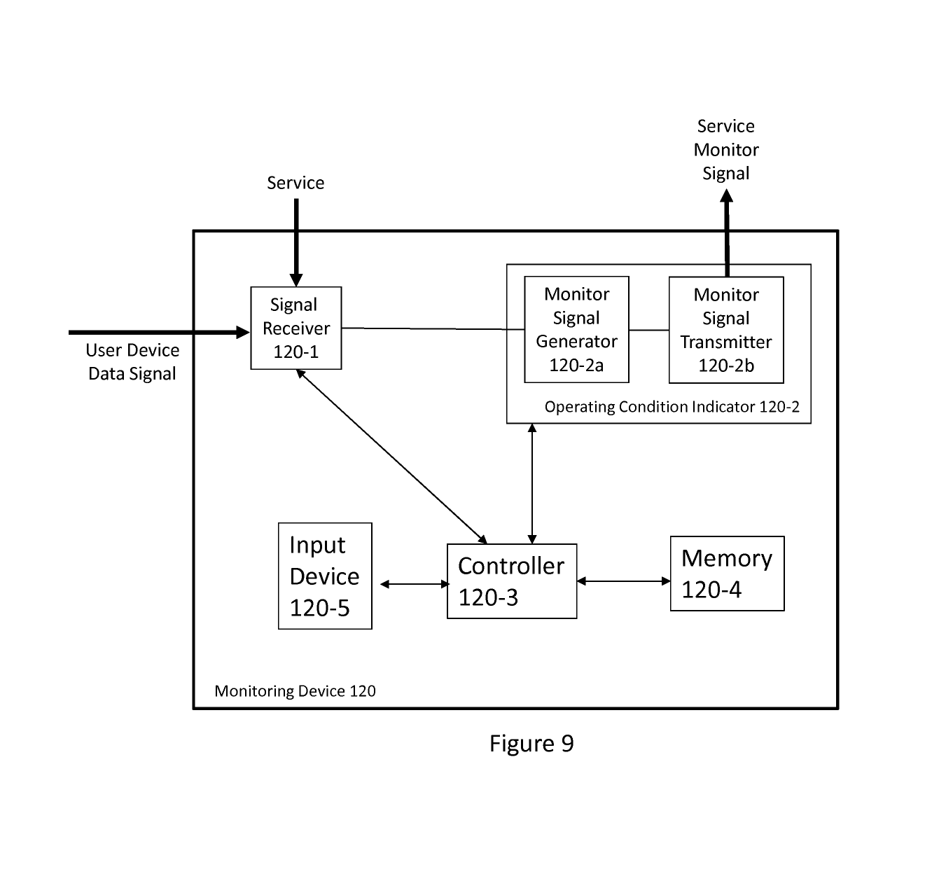

FIG. 9 illustrates a monitoring device 120 which may be used in the distributed system 100, according to another exemplary aspect of the present invention.

The operating condition indicator 120-2 may include, for example, a monitor signal generator 120-2a for generating a service monitor signal based on the received service signal, the service monitor signal describing the operating condition of the service, and a monitor signal transmitter 120-2b (e.g., wired or wireless transmitter) for transmitting the service monitor signal to the service provider (e.g., to the transmitting location 190).

As further illustrated in FIG. 9, the signal receiver 120-1 may receive a user device data signal regarding an operating condition of the service at a user device, and based on the received user device data signal, the operating condition indicator 120-2 may indicate the operating condition of the service at the user device.

The monitoring device 120 may also include a controller 120-3 (e.g., microcontroller, microprocessor, etc.) for controlling an operation of the signal receiver 120-1 and an operation of the operating condition indicator 120-2. The controller 120-3 may include, for example, a display generator, which generates a display screen for displaying the operating condition of the service. The monitoring device 120 may also include a memory device 120-4 (e.g., random access memory (RAM), read-only memory (ROM), etc.) which is accessible by the controller 120-3. The memory device 120-4 may store programs (e.g., software), which may be executed by the controller 120-3 to control an operation of the signal receiver 120-1 and an operation of the operating condition indicator 120-2. The memory device 120-4 may also store data pertaining to service at the receiving location 195 (e.g., at subscriber's home, office or other building). Such data may include, for example, history data describing a history of the service signal and/or the user device data signal.

The monitoring device 120 may also include an input device 120-5 (e.g., keyboard, mouse, touchscreen display, etc.) for inputting data for use by the controller 120-3. For example, the input device 120-5 may be used to program the monitoring device 120 to store a predetermined operating condition in the memory device 120-4, and notify if the operating condition (e.g., detected operating condition) satisfies a predetermined operating condition.

It should also be noted that the monitoring device 120, shown in FIGS. 8 and 9, may include all of the functionality and features described above with respect to the distributed system 100.

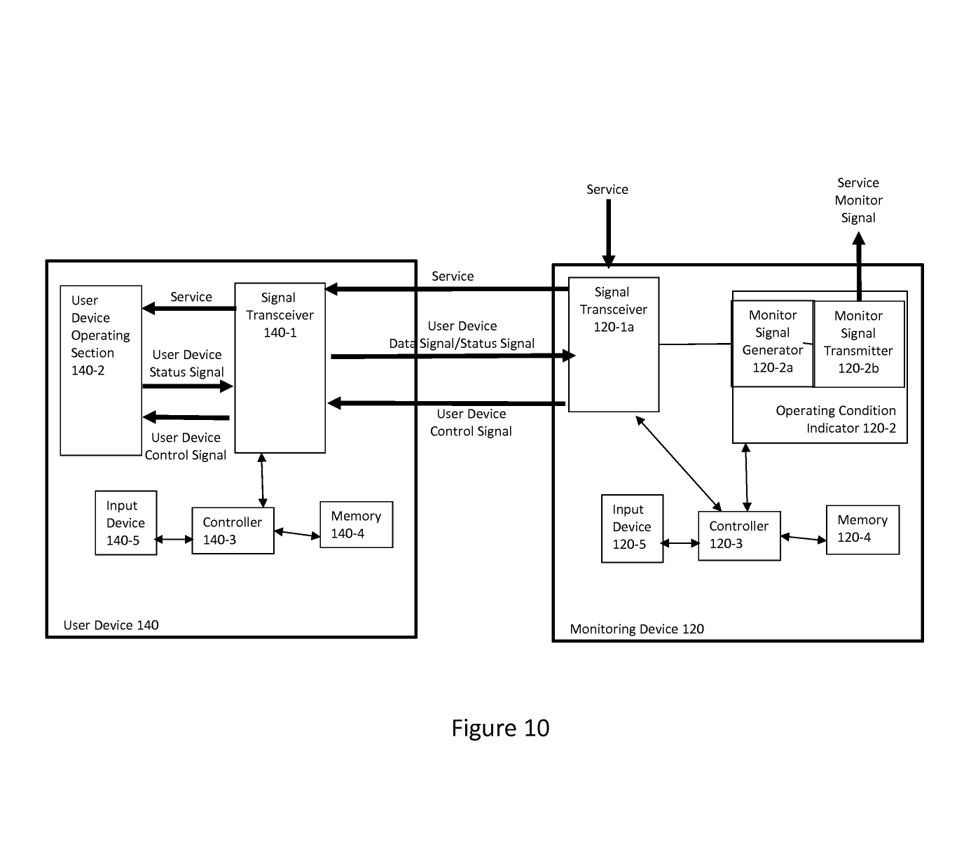

FIG. 10 illustrates a monitoring device 120 and user device 140 which may be used in the distributed system 100, according to another exemplary aspect of the present invention.

As illustrated in FIG. 10, the signal receiver 120-1 in the monitoring device 120 may be replaced with a signal transceiver 120-1a which allows the monitoring device 120 to control the user device 140. That is, the controller 120-4 may generate a control signal and transmit the control signal via the signal transceiver 120-1a to the user device 140 to control (e.g., program) the user device 140.

Further, the user device 140 may include a user device operating section 140-2, which performs the operations of the user device 140 (e.g., where the user device 140 is a television, the user device operating section 140-2 would use the service to generate a display, generate audio, etc.) The user device 140 may also include a controller 140-3 (e.g., microcontroller, microprocessor, etc.) to control an operation of the user device 140 (e.g., in conjunction with the control signal from the monitoring device 120), and a memory device 140-4 (e.g., RAM, ROM, etc.) which may be used to store programs and data. The user device 140 may also include an input device 140-5 (e.g., keyboard, mouse, touchscreen, etc.) that may be used by the user to input data, programs etc. into the user device 140. For example, the input device 140-5 may be used to program the user device 140 with predetermined operating conditions, etc.

In particular, the controller 140-3 may execute the programs stored in the memory device 140-4 in order to control the user device 140. The memory device 140-4 may store history data which describes a history of service used by the user device 140. The monitoring device 120 may also access the history data (e.g., history data may be transmitted to the monitoring device 120 via the user device data signal) and may update or replace the programs stored in the memory device 140-4.

The user device 140 may be programmed with a unique identifier (e.g., unique to the monitoring device 120), which may be stored in the memory 140-4. This may allow the monitoring device 120 to detect the location of the user device 140 in communicating with the user device 140. That is, the identifier may be included in the user device data signal transmitted from the user device 140.

The user device 140 may also be used to integrate the distributed system 100 with a home automation system. For example, the user (e.g., subscriber) may use the operating condition display to cause the monitoring device 120 to control the user device 140 by transmitting the user device control signal to the user device operating section 140-2. The user device operating section 140-2 may communicate a status of the user device operating section 140-2 to the monitoring device 120 via a user device status signal.

Thus, for example, where the user device is a television, the monitoring device 120 may use the user device status signal to determine an on/off of the television, a volume control of the television, a display brightness of the television, etc. and use the controller 120-3 to control the features of the television (e.g., overriding the other controls for the television). As another example, where the user device is a water heater, the monitoring device 120 may use the user device status signal to determine an on/off of the water heater, a water temperature of the water in the water heater, a flow rate of water to the water heater, etc. and use the controller 120-3 to control the features of the water heater (e.g., overriding the other controls for the water heater).

It should be noted that the input node 150 may also include the features of the user device 140 in FIG. 10, except that the signal transceiver 140-1 in the input node 150 would act as a conduit for passing the service through from the monitoring device 120 to the user device 140.

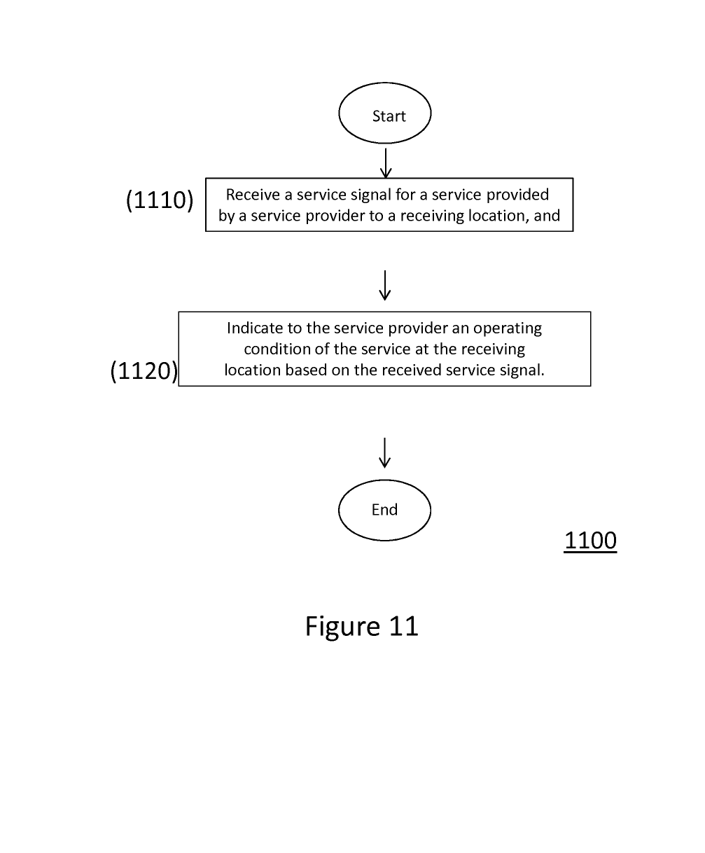

Referring again to the drawings, FIG. 11 illustrates a monitoring method 1100 for monitoring a distributed system (e.g., distributed system 100), according to another exemplary aspect of the present invention.

As illustrated in FIG. 11, the monitoring method 1100 includes receiving (1110) a service signal for a service provided by a service provider to a receiving location, and indicating (1120) to the service provider an operating condition of the service at the receiving location based on the received service signal. For example, the operating condition indicator may be accessible by the service provider, and/or the operating condition indicator may transmit the operating condition to the service provider.

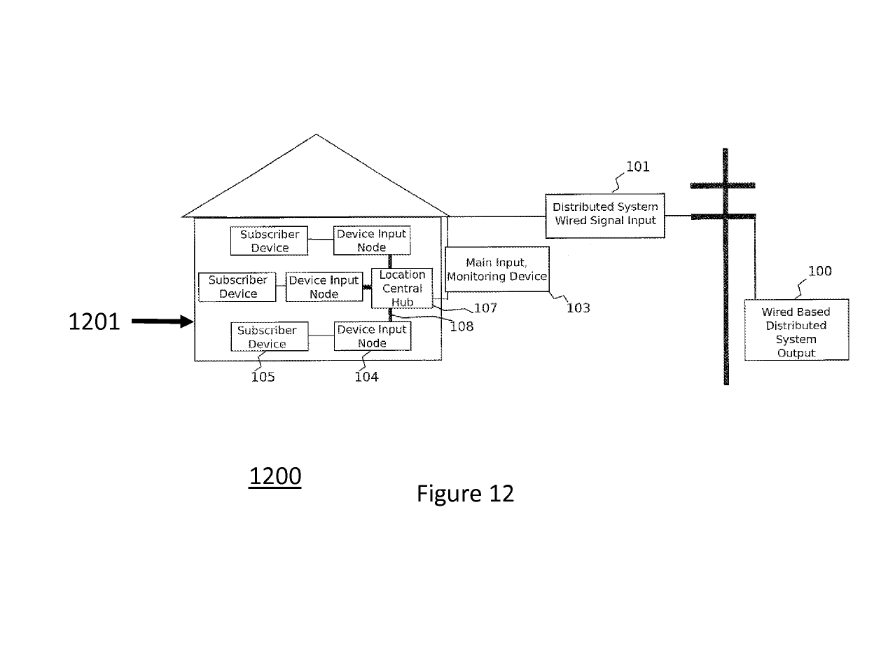

FIG. 12 illustrates a schematic block diagram of a wired distributed system 1200 including a monitoring device 100, according to an exemplary aspect of the present invention.

In particular, FIG. 12 illustrates a structure 1201 with service of a distributed system coming into the structure 1201 by a Wired-Based Distributed System Output 100 to a structure as a Distributed System Wired Signal Input 101 (i.e., typically from a utility pole wire or underground utility wire, such as cable television, telephone or AC electrical power).

In further detail, a Main Input Monitoring Device 103 (e.g., having the features and functions of monitoring device 120) connects to the wire coming from Distributed System Wired Signal Input 101.

The Main Input Monitoring Device 103 continuously monitors the distributed system signal quality. The present invention can monitor for, but not limited to, signal strength, frequency range, data rate and data integrity, crosstalk or interference. The Main Input Monitoring Device 103 in certain exemplary embodiments can store data for further diagnostic evaluation.

In an exemplary embodiment, the Main Input Monitoring Device 103 data or output can be selectively accessed by the distributed system provider, a central or regional service center, a technician at the subscriber location, or by the subscriber itself as a diagnostic and status tool when talking to the provider or doing subscriber-enabled initial diagnostics. The Main Input Monitoring Device 103 data or output can also be programmed to automatically notify selected users based on selected criteria or parameters occurring.

In FIG. 12, after being connected to the Main Input Monitoring Device 103, the main wire feed is input to a structured wire hub Location Central Hub 107. Each device, room or node in the structure 1201 may be connected directly to the Location Central Hub 107 via a “homerun” wire 108 or by other means.

A Device Input Node 104 is connected between Location Central Hub 107 and Subscriber device 105 (e.g., having the features and functions of the user device 140). The subscriber device 105 could be a set-top box, a modem, a television or any device that connects (directly or indirectly) to the Distributed System Wired Signal Input 101 via the Location Central Hub 107 “homerun” distributed wiring method 108.

As noted above, the Device Input Node 104 could be integrated directly into the subscriber device 105.

In an exemplary embodiment, each Device Input Node 104 is uniquely identified and continuously sends data (e.g., via the user device data signal in FIG. 3) to the Main Input Monitoring Device 103. Thus, the same parameters and monitoring criteria of Main Input Monitoring Device 103 can be duplicated by Device Input Node 104 and continuously sent to and stored by the Main Input Monitoring Device 103.

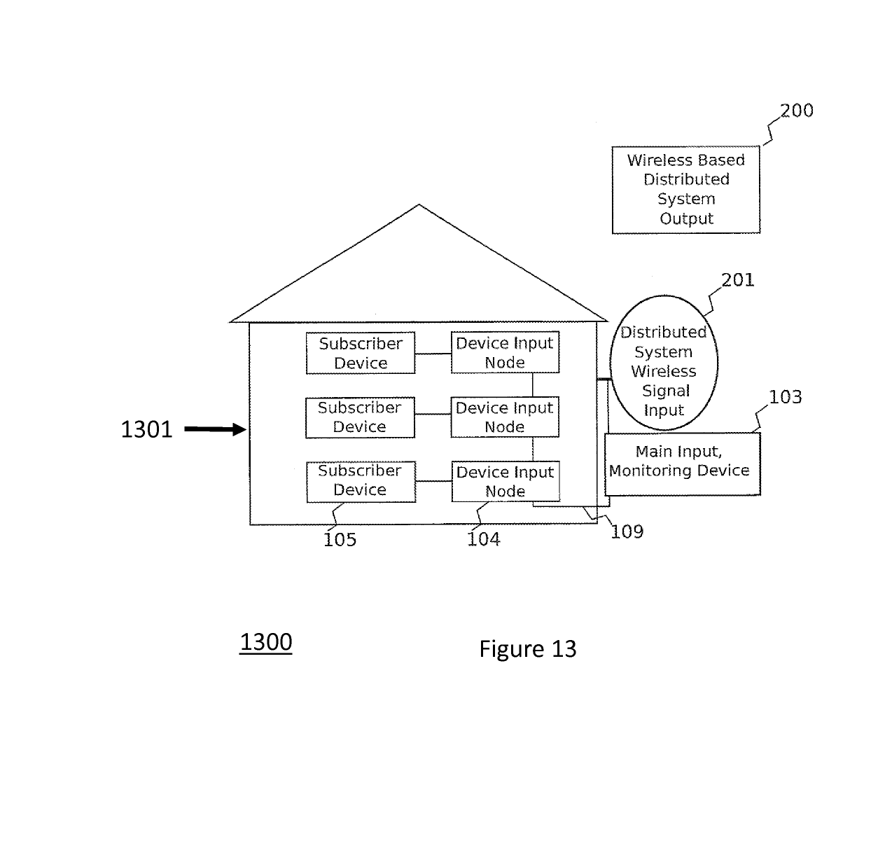

FIG. 13 illustrates a schematic block diagram of a wireless distributed system 1300 including a monitoring device 100, according to an exemplary aspect of the present invention.

In particular, FIG. 13 illustrates a structure 1301 with service of a distributed system coming into the structure 1301 by a Wireless Based Distributed System Output 200 (i.e., typically a satellite, cellular or broadcast signal) broadcasting a wireless signal to a signal pickup device, Distributed System Wireless Signal Input 201 (i.e., such as an antenna or satellite dish).

The Main Input Monitoring Device 103 (e.g., having the features and functions of monitoring device 120) connects to the Distributed System Wireless Signal Input 201.

In FIG. 13 showing the exemplary “wireless” embodiment, after being input to the Main Input Monitoring Device 103, the main wire feed is input to a “daisy-chained” or split wire system Wire & Splitter 109, such that each device, room or node in the structure 1301 is connected after the previous connection or by using one or more splitters after the Wire & Splitter 109.

A Device Input Node 104 is connected between Wire & Splitter 109 and subscriber device 105 (e.g., having the features and functions of the user device 140).

Similar to the wired embodiment described above, subscriber device 105 could be a set-top box, a modem, a television, appliance, security system, radio or any device that connects directly (or indirectly) to the distributed system 101 via the Central Hub 107.

Each Device Input Node 104 continuously sends data to the Main Input Monitoring Device 103. Thus, the same parameters and monitoring criteria of Main Input Monitoring Device 103 can be duplicated by Device Input Node 104 and continuously sent to and stored by the Main Input Monitoring Device 103.

Either Distributed System Wired Signal Input 101 or Distributed System Wireless Signal Input 201 could utilize Location Central Hub 107 and “homerun” distributed wiring 108 (FIG. 12) or direct wire or wire and splitter 109 (FIG. 13).

The Main Input Monitoring Device 103 can be accessed by (but not limited to) several methods.

For example, the Distributed System Wired Signal Output 101 or Distributed System Wireless Signal Output 102 provider could allow access and programming of the Main Input Monitoring Device 103 to the technician or subscriber via a dedicated channel on a television, computer or Internet, or via an “App” (application) for Smartphones or tablet computers Wireless App Based Interface, or future smart devices.

The Main Input Monitoring Device 103 may also have a direct technician connection via a standard data protocol connector, such as, but not limited to, serial, Firewire, USB or wireless protocols such as, but not limited to, Bluetooth.

Referring to FIGS. 1-13, another aspect of the present invention is directed to a computer program product which may include, for example, a computer readable storage medium (hereinafter, the “storage medium”) that may store computer readable program instructions (hereinafter, the “computer program” or “instructions”) for performing the features and functions of the monitoring device 120, the distributed system 100 and the monitoring method 1100. That is, the storage medium may store the instructions thereon for causing a processing device (e.g., computer, instruction execution device, computing device, computer processor, central processing unit (CPU), microprocessor, etc.) to perform a feature or function of the present invention.

The storage medium can be a tangible device that can retain and store the instructions for execution by the processing device. The storage medium may be, for example, but is not limited to, an electronic storage device, a magnetic storage device, an optical storage device, an electromagnetic storage device, a semiconductor storage device, or any suitable combination of the foregoing.

A non-exhaustive list of more specific examples of the storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing.

The storage medium, as used herein, should not be construed as merely being a “transitory signal”, such as a radio wave or other freely propagating electromagnetic wave, an electromagnetic wave propagating through a waveguide or other transmission media (e.g., light pulses passing through a fiber-optic cable), or an electrical signal transmitted through a wire. The processing device can access the instructions on the storage medium. Alternatively, the processing device can access (e.g., download) the instructions from an external computer or external storage device via a network such as the Internet, a local area network, a wide area network and/or a wireless network.

The network may include, for example, copper transmission cables, optical transmission fibers, wireless transmission, routers, firewalls, switches, gateway computers and/or edge servers. For example, the processing device may include a network adapter card or network interface, which receives the instructions from the network and forwards the instructions to the storage medium within the processing device, which stores the instructions.

The instructions for performing the features and functions of the present invention may include, for example, assembler instructions, instruction-set-architecture (ISA) instructions, machine instructions, machine dependent instructions, microcode, firmware instructions, state-setting data, or either source code or object code written in one or more programming languages (or combination of programming languages), including an object oriented programming language such as Java, Smalltalk, C++ or the like, and conventional procedural programming languages, such as the “C” programming language or similar programming languages.

The instructions may execute entirely on the processing device (e.g., a user's computer), partly on the processing device, as a stand-alone software package, partly on the processing device and partly on a remote computer or entirely on the remote computer or a server. For example, the instructions may execute on a remote computer, which is connected to the processing device (e.g., the user's computer) through a network such as a local area network (LAN) or a wide area network (WAN), or may execute on an external computer, which is connected to the processing device through the Internet using an Internet Service Provider.

The processing device may include, for example, electronic circuitry including, for example, programmable logic circuitry, field-programmable gate arrays (FPGA), or programmable logic arrays (PLA) that may execute the instructions by utilizing state information of the instructions to personalize the electronic circuitry, in order to perform a feature or function of the present invention.

It should be noted that the features and functions of the present invention, which are described above with reference to FIGS. 1-13 may be implemented by the processing device executing the instructions. That is, each block of the flowchart illustrations and/or block diagrams, and combinations of blocks in the flowchart illustrations and/or block diagrams, can be implemented by processing device executing the instructions.

The instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

That is, the instructions may be executed by a processing device to cause a series of operational steps to be performed by the processing device to produce a computer-implemented process, so that the executed instructions implement the features/functions/acts described above with respect to the flowchart and/or block diagram block or blocks of FIGS. 1-13.

Thus, the flowchart and block diagrams in the FIGS. 1-13 illustrate not only a method, system, apparatus or device, but also illustrate the architecture, functionality, and operation of the processing device executing the instructions. In this regard, each block in the flowchart or block diagrams may represent a module, segment, or portion of the instructions, which comprises one or more executable instructions for implementing the specified logical function(s). In some alternative implementations, the features or functions in the block may occur out of the order noted in the figures.

For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

With its unique and novel features, the present invention provides a monitoring device, distributed system and monitoring method, which are more efficient and effective than conventional devises, systems and methods.

While the invention has been described in terms of one or more embodiments, those skilled in the art will recognize that the invention can be practiced with modification within the spirit and scope of the appended claims. Specifically, one of ordinary skill in the art will understand that the drawings herein are meant to be illustrative, and the design of the inventive device is not limited to that disclosed herein but may be modified within the spirit and scope of the present invention.

Further, Applicant's intent is to encompass the equivalents of all claim elements, and no amendment to any claim the present application should be construed as a disclaimer of any interest in or right to an equivalent of any element or feature of the amended claim.

What is claimed is:

1. A monitoring device for a distributed system, comprising:
a signal receiver for receiving a service signal for a service provided by a service provider to a subscriber at a receiving location; and
an operating condition indicator which indicates to the service provider an operating condition of the service at the receiving location based on the received service signal.

2. The monitoring device of claim 1, wherein the operating condition indicator comprises:
a monitor signal generator for generating a service monitor signal based on the received service signal, the service monitor signal describing the operating condition of the service; and
a monitor signal transmitter for transmitting the service monitor signal to the service provider.

3. The monitoring device of claim 1, wherein the operating condition indicator comprises:
a display generator which generates a display screen for displaying the operating condition of the service.

4. The monitoring device of claim 1, wherein the service comprises an electrical signal and the operating condition comprises at least one of a signal strength of the electrical signal, a frequency range of the electrical signal, a data rate for the electrical signal, data integrity of the electrical signal, crosstalk for the electrical signal and interference with the electrical signal.

5. The monitoring device of claim 1, wherein the distributed system comprises a user device which uses the service and is located at the receiving location, and
wherein:
the signal receiver receives a user device data signal regarding an operating condition of the service at the user device; and
based on the received user device data signal, the operating condition indicator indicates the operating condition of the service at the user device.

6. The monitoring device of claim 5, wherein the user device comprises one of a television, a telephone, a set-top box, a modem, a computer, a network router, a security device, a light fixture, a heating, ventilation and air conditioning (HVAC) unit, an electrical appliance, a gas appliance and a water faucet.

7. The monitoring device of claim 5, further comprising:
a memory device which stores history data describing a history of at least one of the service signal and the user device data signal.

8. The monitoring device of claim 1, wherein the service comprises at least one of:
a wired service including one of a cable television signal, a telephone signal and an AC electrical power supply; and
a wireless service including one of a satellite signal, a cellular signal and a broadcast signal.

9. The monitoring device of claim 1, wherein the distributed system comprises at least one of a cable television system, a broadband telecommunications system, a satellite television system, an electrical power system, a data system, a natural gas distribution system and a water distribution system.

10. The monitoring device of claim 1, further comprising:
an input device for programming the monitoring device to notify if the operating condition satisfies a predetermined operating condition.

11. A distributed system, comprising:
a service transmitter transmitting a service from a service provider at a transmitting location to a subscriber at receiving location which is remote from the transmitting location; and
a monitoring device which is located at the receiving location, receives a service signal for the service, and indicates to the service provider an operating condition of the service at the receiving location based on the received service signal.

12. The distributed system of claim 11, wherein the monitoring device comprises:
a signal receiver for receiving the service signal for a service provided by a service provider to a receiving location; and
an operating condition indicator which indicates the operating condition of the service at the receiving location.

13. The distributed system of claim 12, further comprising:
a user device which uses the service and is located at the receiving location,
wherein:
the signal receiver receives a user device data signal regarding an operating condition of the service at the user device; and
based on the received user device data signal, the operating condition indicator indicates the operating condition of the service at the user device.

14. The distributed system of claim 13, further comprising:
a device input node which is connected between the monitoring device and the user device and generates the user device data signal.

15. The distributed system of claim 13, wherein the monitoring device comprises a plurality of monitoring devices located at a plurality of receiving locations, respectively, and
wherein the user device comprises a plurality of user devices located at the plurality of receiving locations, respectively.

16. The distributed system of claim 12, further comprising:
a service signal input device which receives the service signal, the signal receiver of the monitoring device receiving the service signal via the service signal input device.

17. The distributed system of claim 16, wherein the service signal input device comprises at least one of a wired signal input device and a wireless signal pickup device.

18. The distributed system of claim 11, wherein the monitoring device indicates the operating condition of the service by transmitting a service monitor signal one of directly to the service provider, via a service center for the distributed system, and via a portable terminal of a service technician for the service provider.

19. The distributed system of claim 11, further comprising:
a display device which receives the service monitor signal and displays an operating condition display for the distributed system based on the service monitor signal.

20. A monitoring method for monitoring a distributed system, comprising:
receiving a service signal for a service provided by a service provider to a subscriber at a receiving location; and
indicating to the service provider an operating condition of the service at the receiving location based on the received service signal.
